(19) United States
(12) Patent Application Publication
(10) Pub. No.: US 2017/0163141 A1
(43) Pub. Date: Jun. 8, 2017

(54) SYSTEM, METHOD, AND APPARATUS FOR ENERGY RECAPTURE USING INDUCTION

(71) Applicant: MARY FALES, SAN DIEGO, CA (US)

(72) Inventor: MARY FALES, SAN DIEGO, CA (US)

(21) Appl. No.: 15/370,523

(22) Filed: Dec. 6, 2016

Related U.S. Application Data
(60) Provisional application No. 62/264,651, filed on Dec. 8, 2015.

(51) Int. Cl. H02K 99/00; H02K 1/34; H02K 1/12

(52) U.S. Cl. CPC H02K 99/10; H02K 1/12; H02K 1/34

(57) ABSTRACT

A system, method, and apparatus for recapture of energy using induction is disclosed. One or more conductive loops may be placed adjacent to a path, for example, a lane of a freeway or a railroad track. The loops may be connected to an electrical conditioning unit. When a magnetized object travels across the path (e.g. car or train), electricity may be produced in the loops by induction. The electricity thus produced may be conditioned, used locally, stored, or sent back to the grid for use.

### CLAIM TO PRIORITY UNDER 35 U.S.C. §119

The present Application for Patent claims the benefit of U.S. Provisional Application No. 62/264,651 filed on Dec. 8, 2015, entitled, “System, Method, and Apparatus for Energy Recapture Using Induction,” owned by Applicant and expressly incorporated herein by reference in its entirety.

### FIELD

The disclosed embodiments relate to a system, method, and apparatus for recapture of energy using induction.

### BACKGROUND OF THE INVENTION

The continuation of modern life is dependent on the availability of energy resources that power our lives. Because of our constant consumption, sources of energy continually become more scarce and expensive. Meanwhile, some energy is expended that can be recaptured as we go about our daily lives. Therefore, there is a need in the art for a system, method and apparatus to recapture some of the expended energy and convert it into useable forms.

### BRIEF SUMMARY OF THE INVENTION

In an embodiment, an apparatus for recapture of energy using induction is described, comprising, a conductive loop attached to a voltage conditioner; the conductive loop being placed adjacent to a path; and the conductive loop being configured to induce electric current upon movement of a magnetized object along the path.

In yet another embodiment, a method for recapture of energy using induction is described, comprising, placing a conductor loop adjacent to a path, the conductive loop having between one to ten turns; inducing current in the conductor loop by utilizing magnetized objects magnetic fields that inherently move along the path; and conditioning the generated current.

In another embodiment, a system for recapture of energy using induction is described, comprising, at least one conductive loop imbedded in a lane of a freeway; the conductive loop attached to a voltage conditioner module, the voltage conditioner module not biasing the at least one conductive loop with electrical energy; and the voltage conditioner module configured to receive and condition current induced in the at least one conductive loop.

### BRIEF DESCRIPTION OF THE DRAWINGS

The following embodiments may be better understood by referring to the following figures. The figures are presented for illustration purposes only, and may not be drawn to scale or show every feature, orientation, or detail of the embodiments. They are simplified to help one of skill in the art understand the embodiments readily, and should not be considered limiting.

FIG. 1A illustrates some basic concepts of induction used in the embodiment(s).

FIG. 1B illustrates another basic concept of induction used in the embodiment(s).

FIG. 2A illustrates how a magnetic object may induce electricity in a conductive loop used in the embodiment(s).

FIG. 2B illustrates how a magnetic object may induce electricity in a conductive loop of N turns used in the embodiment(s).

FIG. 3A illustrates how a magnetic object may be used for recapture of energy with a series of loops per path in the embodiment(s).

FIG. 3B illustrates how a magnetic object may be used for recapture of energy with a series of conductors with N loops per path in the embodiment(s).

FIG. 4 illustrates a method for recapture of energy.

FIG. 5 illustrate an embodiment where a vehicle may be used to induce electricity in a conductive loop/s placed adjacent to a path.

FIG. 6 illustrates an embodiment where a train may be used to induce electricity in a conductive loop/s placed adjacent to railroad tracks.

### DETAILED DESCRIPTION OF THE INVENTION

Each of the additional features and teachings disclosed below may be utilized separately or in conjunction with other features and teachings to provide a system, method, and apparatus for energy recapture using induction. Representative examples of the following embodiments, will now be described in further detail with reference to the attached drawings. This detailed description is merely intended to teach a person of skill in the art details for practicing the preferred aspects of the teachings and is not intended to limit the scope of the embodiments.

A system, method, apparatus for energy recapture using induction is disclosed. Broadly speaking, the various disclosed embodiments describe utilizing common moving objects that are magnetized to induce electric power in conductors. Moving objects may be naturally magnetized, magnetized through the addition of a magnetic object, or become magnetized through the movement across the earth's magnetic field. An object (or magnetizeable parts of an object) may become magnetized by the earth's magnetic field through normal operation; for example, by driving a car around.

Moving a magnetic field through a conductor will produce current in the conductor according to commonly well-known laws of electromagnetic induction. Because the moving magnetic field pushes the electrons in the conductor causing a flow of electrons in the conductor. Or stated a different way, a conductor loop produces a magnetic field to oppose the change in magnetic field which produced it. This flow of energy is called electrical current and the phenomenon itself is broadly termed induction.

The described embodiments are directed to producing current (or electric power) as a current source (generator or power source), and not what is known in the art as a “vehicle presence indicator.” A vehicle presence indicator operates oppositely by placing (biasing) electrical energy on a loop embedded in the ground at a frequency tuned for the circuit's purpose (detecting a car). When a car is stopped on the loop, like at a red light, the vehicle's metal over the loop area changes the circuit's inductance (net effect being a reduction). The change in the inductance is detected in a control unit that uses the information to control signal lights and traffic. The disclosed embodiments do not put electrical energy on the loop (bias it), rather electrical energy from the loop is received when a magnetized object moves through the loop (sometimes termed motion induction).

The moving magnetic object may be any magnetized object that creates a magnetic field. For example, the magnetic object may be a vehicle, or parts of a vehicle that have become magnetized. A vehicle may be a wheeled vehicle such as a car, bus, truck, a recreational vehicle (RV), or motorcycle. It may also be a railed vehicle such as a train, or an object that runs on a fixed path like an elevator in a shaft. A vehicle has materials, like steel (ferrous metal), that are naturally magnetized when the magnetizeable material vibrates and moves through the earth's magnetic field. In addition, parts of the vehicle may be electric and produce a magnetic field of their own. Like an electric motor. This is especially true for hybrid cars and electric trains. Even if the moving object is not naturally magnetized, or if its magnetic field is weak, a magnet may be added to the object, creating an appropriately magnetized moving object.

Electromagnetic induction may be used to recapture the energy from the movement of these magnetized objects by inducement of electricity in conductors that are embedded in, attached to, adjacent to, placed in proximity of, hung in proximity to, or attached to the surface of a path where the magnetized object travels. In general, the moving magnetic object's magnetic field needs to pass through the conductor such that the magnetic field is not parallel to the conductor's area as explained in more detail below.

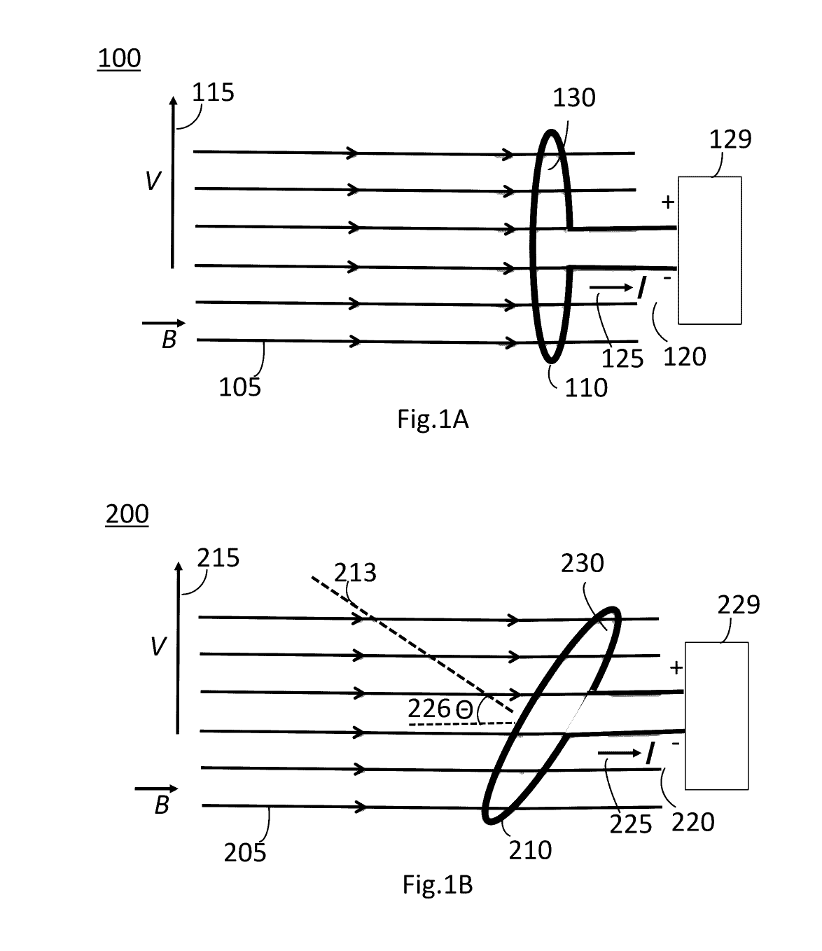

FIG. 1A illustrates some basic concepts 100 of induction used in the embodiment(s). In FIG. 1A the magnetic field 105 as denoted by B, is shown drawn as a series of arrows. Conductor 110 is shown perpendicular to magnetic field 105. Conductor 110 has an area 130. When the magnetic field 105 moves through the area of the loop 130 in the direction of V 115, current I 120 is induced in the direction shown 125. In addition, the conductor 110 is attached to a Voltage Conditioning Unit (VCU) 129 forming a closed circuit amongst other things. A VCU 129 as is well known in the art may take AC or DC currents and convert them into a different forms. For example, DC current coming from the Conductor 110 may be converted into AC. The voltage may be stepped up/down, stored, filtered, conditioned, summed, or amplified as is well known in the art.

Conductors 110 are well known in the art. A conductor is any material that can conduct electricity. Conductor 110 may comprise any variety of conductive materials for example, copper, aluminum, or gold. In an embodiment wire that is between 12-18 AWG gauge may be used as a conductor. In some designs, an iron core (or ferromagnetic metal) may also be considered a conductor in induction (such as in a transformer), but use of a large area of conductor produces undesired eddy currents (drag). Sometimes conductors are laminated to help reduce eddy currents. Also, some conductors 110 are composed of conductive material, encased within non-conductive coating. For example, an insulated wire. Although there may be some loss due to eddy currents (surface of conductor wire), the dominant current induced in the conductor loop 110 will be I 120 as described above. Moreover, any back electromotive force (emf) can be taken into account based on the overall application and design as is well known in the art.

A conductor may have one or more loops. A conductor 110 that has N number of turns is well known in the art as a coil. However, herein, a conductive loop with N turns may be used in the description instead of coil. In an embodiment a loop may be used that has between 10-250 uH. In one of the embodiments disclosed, the number of turns in the loop may be from 1-6, in another embodiment the number of turns of the coil may be from 1-10. In addition, the loop may have any number of shapes such as a circle, a square, or a rectangle. In other words, a loop doesn't have to be a literal “loop” shape in order to function.

FIG. 1B illustrates another basic concept of induction 200 used in the embodiment(s). The strength of the current produced is in part dependent on the magnetic flux φ. Magnetic flux φ is the quantity of magnetic field that penetrates a conductor area at right angles. The most current I 220 may be produced when the magnetic field B 205 is perpendicular to the area of conductor loop 230. FIG. 1B helps demonstrate what occurs when the magnetic field B 205 is not perpendicular to the area of conductor loop. FIG. 1B shows the magnetic field 205 moving in the direction of V 215 through the area of the loop 230 at angle θ 226 producing the current I 220 in the direction shown by arrow 225. The voltage condition module 229 is shown creating a closed loop for the conductor 210 as well as other things. In a simple situation where the field passes at right angles through a flat surface, this quantity is the strength of the magnetic field B 205 multiplied by the area of the conductor 230. Where the field B 205 is not at right angles to the surface 230, the angle θ 226 made by the magnetic field lines B 205 to the normal vector of the surface 213 must be taken into account (product is multiplied by the cosine of angle θ 226). The most power may be produced when the magnetic field flux lines are perpendicular to the inductor loop. Reversely, the least amount of current may be produced when the magnetic flux lines are parallel to the inductor loop. A simplified mathematical expression, that expresses this relationship, is as follows:

φ=BA cosθ Equation 1.)
Where the magnetic flux, φ is measured in webers (Wb)
B is the strength of magnetic field measured in Teslas (T),
A is the area of conductor loop measured in meters; and
θ is the angle between the magnetic field and the normal vector of the surface.

The area of the conductive loop 230 depends on its measurements and can be calculated according to its geometrical shape. For example, if the conductive loop is circular, the area of the conductive loop can be measured by the well known formula A=Πr².

A vehicle that has magnetized parts, like an engine, may have complicated magnetic field lines (shapes) whose majority of lines may or may not be perpendicular to the conductor area. Thus, the magnetic fields will vary between makes of cars (magnetized objects). For example, one model of car may have a stronger magnetic field strength than another model. Or some magnetized objects may have a north or south orientation variation in the magnetic field that the VCM 229 would need to accommodate for. For example, the VCM 229 may be designed to accept both directions of current (polarity) produced from a north or sough orientated magnetic filed. Or it may have a protection type circuit that only accepts current from one direction (polarity). Thus, the induced current produced may vary and the VCM 229 will need to take into account the variations. For simplicity sake, the drawings reflect idealistic simple flux patterns.

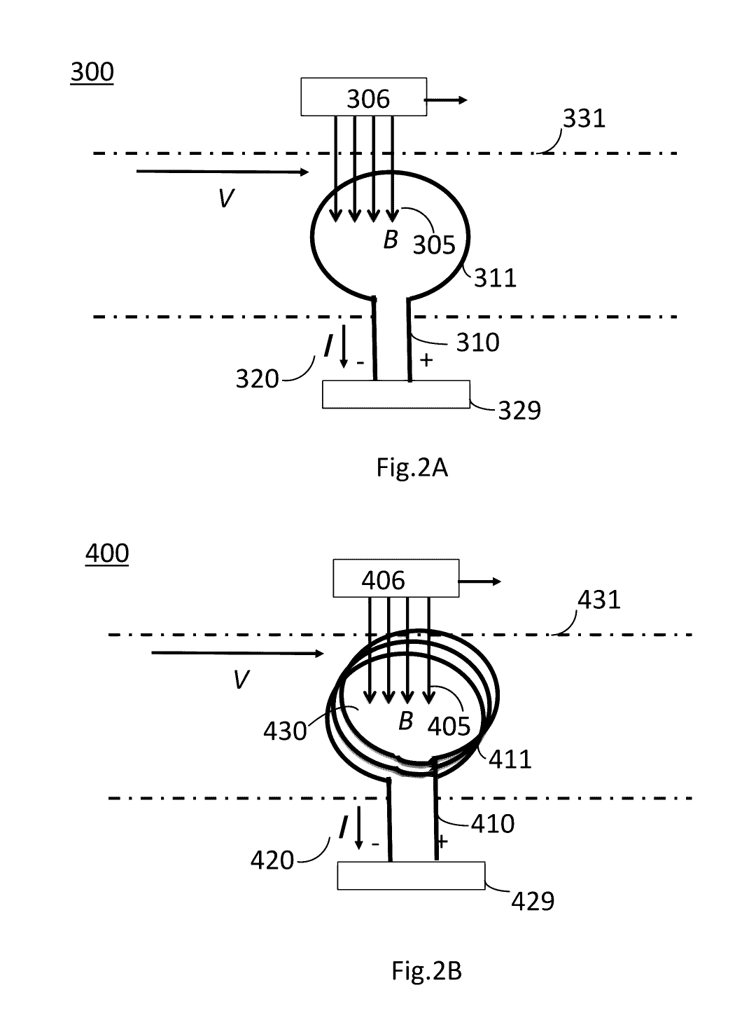

FIG. 2A illustrates how electricity may be recaptured by induction 300 in a conductor 310 having a conductive loop 311 placed adjacent to a path 331. The conductive loop 311 may be embedded in the path, attached to the path, or otherwise placed on, over, or near the path such that the magnetic field B 305 from the moving object 306 would pass through the conductive loop 311. A conductor 310 may be connected to a voltage conditioning unit 329 forming a closed circuit amongst other functions. When a magnetized object 306 travels along the path 331, the movement of the magnetized object 306 in relation to the conductive loop 311 causes the induction of electrical energy I 320 in the direction shown by the arrow.

Path 331 may be any route, road, course, or track along which something moves. For instance, path 331 may be a hard paved or packed surface for vehicles, a street, an avenue, a route, a path, an aisle, a railway, a freeway lane, a track, a tunnel, or shaft. Path 331 may be horizontal, like a street, or vertical such as an elevator shaft, or at any other angle. In addition, a path may be straight, curved, or even circular (e.g. path along a Ferris wheel).

There may be one or more conductors 310 placed adjacent to the path in series. Each conductor 310 may be placed adjacent to the path in various ways. For example, it may be embedded in grooves in the path 331. The grooves may be covered by material such as plastic polymers. Alternatively, the conductor 310 may be attached to, or otherwise placed close to the path 331. For example, not embedded. The conductors 310 may be spaced apart for optimized effect based on the nature of the path and the moving objects. For example, the average magnetic field strength, speed of the moving objects down the path, and steady state times.

FIG. 2B illustrates how electricity may be induced in a conductor 410 that is embedded in a path 431 having a conductive loop 411. The conductive loop may have one or more turns N. The conductive loop 411 may be embedded in the path, attached to the path, or otherwise placed on, over, or near the path 431 such that the magnetic field B 405 from the moving object 406 would pass through the conductive loop 411. Conductor 410 may be connected to a voltage conditioning unit 429 forming a closed circuit, amongst other things. When a magnetized object 406 travels along the path 431, the movement of the magnetized object 406 in relation to the conductive loop 411 causes the induction of electrical energy I 420 in the direction shown by the arrow. A conductive loop with N number of turns may also be known in the art as a coil 411. To increase the amount of electrical energy that is produced, a number of loops N of sized area 430 may be used. To this end, N number of turns can be made in a loop forming a coil 411 as shown in FIG. 2B. In a tightly wound coil 411 with N turns, the magnetic flux y can be calculated as:

φ=NBA cosθ Equation 2.)
Where the magnetic flux, φ is measured in webers (Wb),
N is the number of turns in the coil,
B is the strength of magnetic measured in Teslas (T);
A is the area of conductor loop measured in meters square.

The area of the conductive loop 430 depends on its measurements and can be calculated according to its geometrical shape as discussed above as is well known in the art.

The electromagnetic force (emf E) can be measured using the following formula: (electromagnetic force (whose units are volts)) is:

E=(Δφ/t)=(ΔNBA cosθ/t) Equation 3.)
Where E is emf (electromagnetic force) measured in volts,
φ is the change in the magnetic flux measured in webers (Wb)
t is time in seconds,
N is the number of turns in the loop,
B is the strength of magnetic field measured in Teslas (T),
A is the area of conductor loop measured in meters; and
θ is the angle between the magnetic field and the normal vector of the surface.

In other words, the emf is equal to the rate of change of the magnetic flux. Or:

$$ɛ = - N \frac{d {Φ}_{B}}{d t}$$

Moreover, the amount of the current induced may be influenced by the distance of the magnet from the induction loop, so that the closer the magnet is to the inductor loop the greater the emf produced. So the lower a vehicle is to the ground, the higher the magnetic filed strength of the vehicle is. Also, other relationships from the equations are apparent to one of ordinary skill in the art: e.g. the faster the moving object 406 moves through the loop 411, or the more number of loops (N), the greater the emf produced. As an example, a vehicle with a 55 mG magnetic field strength (B=5.5 uT), and a coil of 6 (N=6) turns and circular surface area of 0.66 m, traveling at 60 MPH over the coil, would produce (ideally), 0.4 mV. Once a current is induced on the conductor, ideally, allowing the coil to reach a steady state before the next vehicle travels over the coil would produce more current. Placement of the coils (e.g. distance between conductors) on the path in relation to average speed of the vehicles may help produce more power.

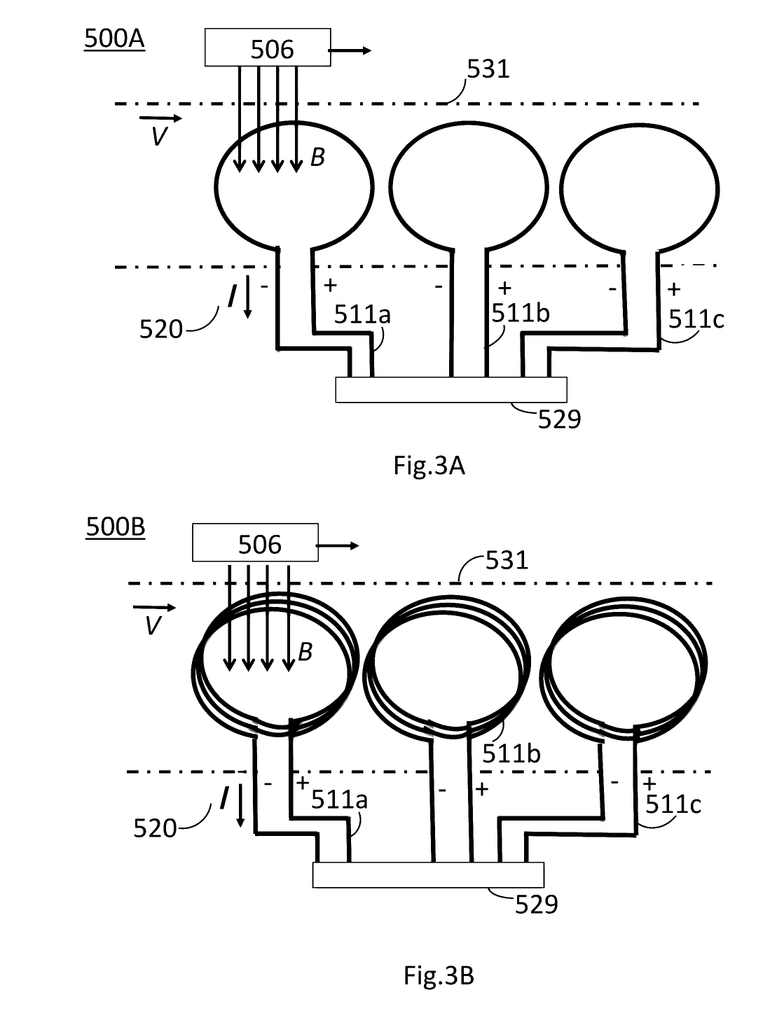

FIG. 3A illustrates how a moving magnetic object may be used for recapture of energy in a sequence of loops per path in the embodiment(s). In embodiment 500A, one or more conductive loops 511a-c may be placed adjacent to path 531. Conductive loops 511a-c may be in series (meaning in a row physically and not necessarily meaning circuit series) down path 531 and connected to a voltage conditioning unit 529. The conductors may be placed in a circuit in series, in a circuit in parallel or a combination of the two as is well known in the art (placing coils in series in a circuit increases the total inductance). When the magnetized object 506 moves along path 531 through conductor 511a the magnetic field B of the object 506 may be used to induce current I 520 in the direction shown by the arrow. The resulting current I 520 may then be directed to an electrical conditioning unit 529 for further processing. The process will repeat as the moving object 506 travels across consecutive conductive loops 511b, 511c, and so forth. Fig. 3B illustrates the same concept of FIG. 3A except it illustrates an embodiment 500B in which conductor loops 511a-c may have N turns.

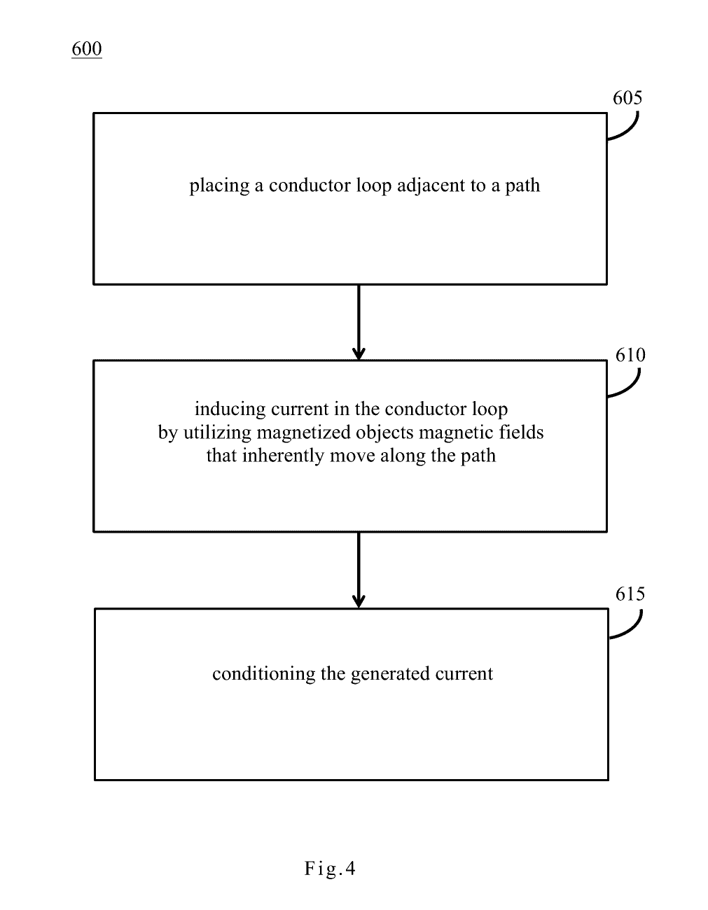

FIG. 4 illustrates a method for recapture of energy. The method may be performed, for example, using any of the embodiments disclosed in the figures. The method 600 may start with the step 605 placing a conductor loop adjacent to a path. In an embodiment, the conductive loop may have between one to ten turns. At step 610, inducing current in the conductor loop by utilizing magnetized objects magnetic fields that inherently move along the path. And in step 615, conditioning the generated current.

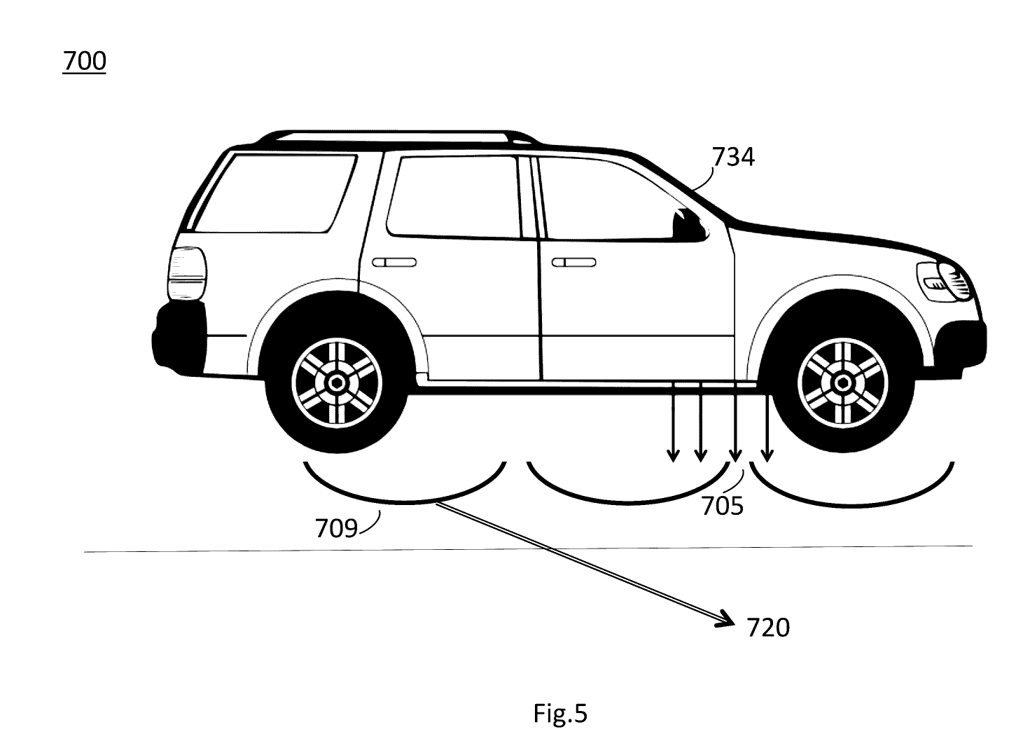

FIG. 5 illustrate embodiments 700 where the magnetic field associated with a car (a type of vehicle) 734 may be used to induce electricity in a series of loops 709 placed along a freeway lane (e.g. path). The path may be a street, a freeway, or a driveway, an underground garage, or any other path that vehicles commonly travel on. The movement of a car 734 in the earth's magnetic field may cause some metallic parts of the car to become magnetically charged, creating a magnetic field 705. When car 734 drives over the embedded loop/s 709 adjacent to the path, the lines of the car's magnetic field 705 move through the conductor loop/s 709 inducing electric current as described above. The electric power may then go to a VCM to be conditioned as described above 720. More current may be induced if the cars are driving faster, or if there are more turns in the loop/s 709. Moreover, a group of loop/s 709 may be connected in a circuit in series and form a larger inductive element to the circuit. A group of loop/s 709 may also be connected in parallel. Also, the loop/s 709 may be isolated inductively in a circuit from each other. FIG. 7 illustrates loop/s 709 placed on one side of a street (lane), but it is to be understood and within the scope of the disclosure loop/s may be placed in more than one lane, sections of lanes, or on both sides of the streets (both traffic directions).

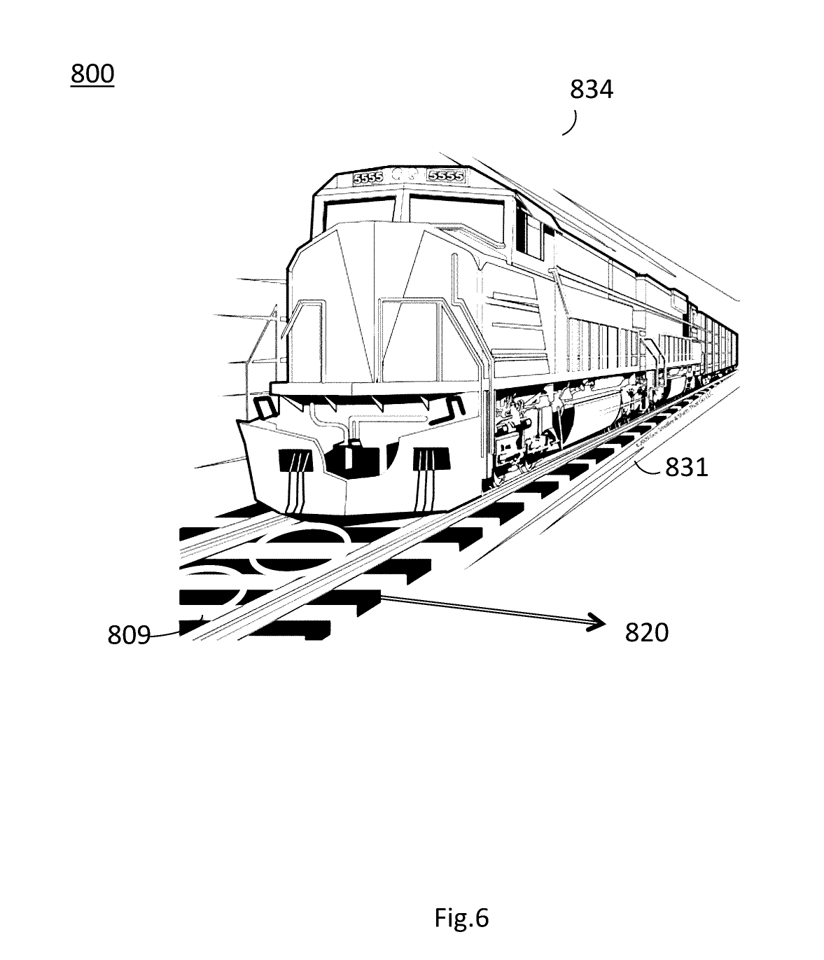

FIG. 6 illustrates an embodiment 800 where a train 834 (a type of vehicle) may be used to induce electricity in loops 809 placed adjacent to a path. In this embodiment, the path may be one or more railroad tracks that trains run on. Train 834 may have a magnetic field along the undercarriage and axels, because of the movement of its metallic parts through the earth's magnet field. Measured values for these types of fields (around an axel) may be for example, 0.1 to 55 mG (milliguass). Wherein one gauss equals 1×10⁻⁴ tesla (100 μT) (1 T=10000 G). In addition, with electric trains, the electric engine creates a magnetic field. Electric trains may have stronger magnetic fields then their non-electrical counterparts. When train 834 drives over the railroad track 831, the magnetic field along the train undercarriage will induce a flow of current in the loop/s 809. The electric power may then go to a VCM to be conditioned as described above 820. More current may be induced if the train 834 is driving faster, or if there are more turns in the loop/s 809. In addition, more current may be produced if the magnetic portions of the train are closer to the loops 809.

In another embodiment an object may be equipped with a magnet to induce electricity. For example, a magnet may be attached to a shopping cart (a type of vehicle). Conductive loops may be embedded in, or attached to, the store's aisles. As the shopping cart moves along the aisle, the magnet moves through the loops. Other embodiments such as a Ferris wheel (circular movement of an object along a path) is envisioned and within the scope of the disclosure.

The foregoing description of the preferred embodiments has been presented for purposes of illustration and description. It is not intended to be exhaustive or to limit the embodiments to the precise form or to exemplary embodiments disclosed. Obviously, many modifications and variations will be apparent to practitioners skilled in this art. Similarly, any process steps described might be interchangeable with other steps in order to achieve the same result. The embodiments were chosen and described in order to best explain the principles of the embodiments and its best mode practical application, thereby to enable others skilled in the art to understand the various embodiments and with various modifications as are suited to the particular use or implementation contemplated. It is intended that the scope of the embodiments be defined by the claims appended hereto and their equivalents. Reference to an element in the singular is not intended to mean “one and only one” unless explicitly so stated, but rather means “one or more.” Moreover, no element, component, nor method step in the described disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . . ”

In addition, the conjunction “and” when used in the claims is meant to be interpreted as follows: “X, Y and Z” means it may be either X , Y or Z individually, or it may be both X and Y together, both X and Z together, both Y and Z together, or all of X, Y, and Z together.

It should be understood that the figures illustrated in the attachments, which highlight the functionality and advantages of the described embodiments, are presented for example purposes only. The architecture of the described embodiments are sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the described embodiments in any way. It is also to be understood that the steps and processes recited in the claims need not be performed in the order presented.

Also, it is noted that the embodiments may be described as a process that is depicted as a flowchart, a flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed. A process may correspond to a method, a function, a procedure, a subroutine, a subprogram, or the like. When a process corresponds to a function, its termination corresponds to a return of the function to the calling function or the main function. A process or method may be implemented with a processor, or similar device, or any combination of hardware and software.

The various features of the embodiments described herein may be implemented in different systems without departing from the embodiments. It should be noted that the foregoing embodiments are merely examples and are not to be construed as limiting the embodiments. The description of the embodiments is intended to be illustrative, and not to limit the scope of the claims. As such, the described teachings may be readily applied to other types of apparatuses and many alternatives, modifications, and variations will be apparent to those skilled in the art.

What is claimed is:

1. An apparatus for recapture of energy using induction, comprising:
a conductive loop attached to a voltage conditioner;
the conductive loop being placed adjacent to a path; and
the conductive loop being configured to induce electric current upon movement of a magnetized object along the path.

2. The apparatus of claim 1, wherein the conductive loop contains between one to ten turns.

3. The apparatus of claim 1, wherein the conductive loop is one of: embedded in, attached to, placed in proximity of, or hung in proximity to the path.

4. The apparatus of claim 1, further comprising: more than one conductive loops are placed adjacent to the path.

5. The apparatus of claim 1, wherein the path is one of: a route, a course, a track, a road, a freeway, a lane, a street, a highway, an avenue, an aisle, a railway, a rail, a tunnel, a runway, a walkway, or a shaft.

6. The apparatus of claim 1, wherein the magnetized object is a vehicle.

7. The apparatus of claim 6, wherein the vehicle is one of a car, train, a bus, a truck, a plane, a recreational vehicle, or a motorcycle.

8. The apparatus of claim 1, wherein the magnetized object comprises a magnet attached to a moving object.

9. A method for recapture of energy using induction comprising:
placing a conductor loop adjacent to a path, the conductive loop having between one to ten turns;
inducing current in the conductor loop by utilizing magnetized objects magnetic fields that inherently move along the path; and
conditioning the generated current.

10. A system for recapture of energy using induction, comprising:
at least one conductive loop imbedded in a lane of a freeway;
the conductive loop attached to a voltage conditioner module, the voltage conditioner module not biasing the at least one conductive loop with electrical energy; and
the voltage conditioner module configured to receive and condition current induced in the at least one conductive loop.

11. The system of claim 10, wherein the conductive loop contains between one to ten turns.

12. The system of claim 10, wherein the conductive loop is embedded in the lane.

13. The system of claim 12, wherein the conductive loop is embedded in the lane between one to six inches below the lane's surface.

14. The system of claim 10, wherein more than one conductive loops are placed consecutively in the lane.

15. The system of claim 10, wherein the magnetized object is a truck, car, bus, a motorcycle, recreational vehicle, or other wheeled vehicle.
